(19) United States
(12) Patent Application Publication
(10) Pub. No.: US 2021/0354836 A1
(43) Pub. Date: Nov. 18, 2021

(54) SYMMETRICAL DUAL ACTION RESTRAINT

(71) Applicant: GOODRICH CORPORATION, Charlotte, NC (US)

(72) Inventors: Michael A. Luzader, Laveen, AZ (US); Jose Morales, Chandler, AZ (US)

(73) Assignee: GOODRICH CORPORATION, Charlotte, NC (US)

(21) Appl. No.: 17/233,226

(22) Filed: Apr. 16, 2021

Related U.S. Application Data
(60) Provisional application No. 63/023,595, filed on May 12, 2020.

(51) Int. Cl. B64D 25/14

(52) U.S. Cl. CPC B64D 25/14

(57) ABSTRACT

A restraint assembly for an evacuation slide is disclosed. In various embodiments, the restraint assembly includes a first strap having a first end configured for attachment to an inflatable tube at a first location, intermediate a head portion and a foot portion, and a second end configured for attachment to the inflatable tube at a second location, proximate the foot portion; a second strap having a first end configured for attachment to the inflatable tube at a third location, distal of the second location, the second strap having a first aperture and a second aperture, the second aperture spaced a distance from the first aperture; a first loop configured for attachment to the inflatable tube at the second location and configured for threading through the first aperture; and a second loop configured for attachment to the inflatable tube at the second location and spaced the distance from the first loop.

### CROSS-REFERENCE TO RELATED APPLICATIONS

This application claims priority to, and the benefit of, Provisional Patent Application No. 63/023,595, filed May 12, 2020 and titled “SYMMETRICAL DUAL ACTION RESTRAINT,” which is incorporated herein by reference in its entirety for all purposes.

### FIELD

The present disclosure relates generally to inflatable evacuation systems and, more particularly, to methods and apparatus used to reduce inflation failures during deployment.

### BACKGROUND

Inflatable evacuation systems may be found on various structures, including aircraft, boats, offshore drilling platforms and the like. The systems are typically equipped with an inflatable device, such as, for example, an inflatable slide or an inflatable raft, configured to facilitate rapid evacuation of persons in the event of an emergency. The slides or rafts are typically stored in an uninflated condition on the structure—e.g., a commercial aircraft—to be evacuated in a location readily accessible for deployment.

For evacuation slides employed with aircraft, where it is necessary to evacuate the passengers and crew immediately, it is necessary to deploy the slides in the correct attitude under possibly adverse weather conditions including strong winds. In these weather circumstances, the slide may become twisted by the winds, rendering it unusable as a portion of the slide becomes skewed under the aircraft thereby preventing its proper deployment.

### SUMMARY

A restraint assembly for an evacuation slide having an inflatable tube that defines a head portion and a foot portion is disclosed. In various embodiments, the restraint assembly includes a first strap having a first end configured for attachment to the inflatable tube at a first location, intermediate the head portion and the foot portion, and a second end configured for attachment to the inflatable tube at a second location, proximate the foot portion; a second strap having a first end configured for attachment to the inflatable tube at a third location, distal of the second location, the second strap having a first aperture and a second aperture proximate a second end of the second strap, the second aperture spaced a first distance from the first aperture; a first loop configured for attachment to the inflatable tube at the second location and configured for threading through the first aperture; and a second loop configured for attachment to the inflatable tube at the second location and spaced the first distance from the first loop.

In various embodiments, the second loop has a length about equal to the first distance. In various embodiments, the first loop is configured for threading through the second loop. In various embodiments, a release pin is attached to the second end of the first strap. In various embodiments, the release pin is configured for threading through the first loop following the first loop being threaded through the second loop. In various embodiments, the first aperture is defined by a first grommet. In various embodiments, the second aperture is defined by a second grommet.

In various embodiments, the first location is spaced a second distance from the second location and the first strap defines a first strap length that is less than the second distance. In various embodiments, the third location is positioned on the foot portion. In various embodiments, the second strap defines a second strap length that is less than the first strap length.

An evacuation slide is disclosed. In various embodiments, the evacuation slide includes an inflatable tube that defines a head portion and a foot portion; a first strap having a first end attached to the inflatable tube at a first location, intermediate the head portion and the foot portion, and a second end attached to the inflatable tube at a second location, proximate the foot portion; a second strap having a first end attached to the inflatable tube at a third location, distal of the second location, the second strap having a first aperture and a second aperture proximate a second end of the second strap, the second aperture spaced a first distance from the first aperture; a first loop attached to the inflatable tube at the second location and configured for threading through the first aperture; and a second loop attached to the inflatable tube at the second location, the second loop spaced the first distance from the first loop.

In various embodiments, the second loop has a length about equal to the first distance. In various embodiments, the first loop is configured for threading through the second loop. In various embodiments, a release pin is attached to the second end of the first strap. In various embodiments, the release pin is configured for threading through the first loop following the first loop being threaded through the second loop. In various embodiments, the first aperture is defined by a first grommet. In various embodiments, the second aperture is defined by a second grommet.

In various embodiments, the first location is spaced a second distance from the second location and the first strap defines a first strap length that is less than the second distance. In various embodiments, the third location is positioned on the foot portion. In various embodiments, the second strap defines a second strap length that is less than the first strap length.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 is a schematic view of an evacuation slide coupled to an aircraft, in accordance with various embodiments;

FIGS. 2A, 2B, 2C, 2D and 2E illustrate a restraint assembly undergoing various steps of a packing process, in accordance with various embodiments;

FIGS. 3A, 3B, 3C and 3D illustrate an evacuation slide undergoing various steps of a deployment process, in accordance with various embodiments; and

FIGS. 4A and 4B illustrate an evacuation slide undergoing various steps of a deployment process, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

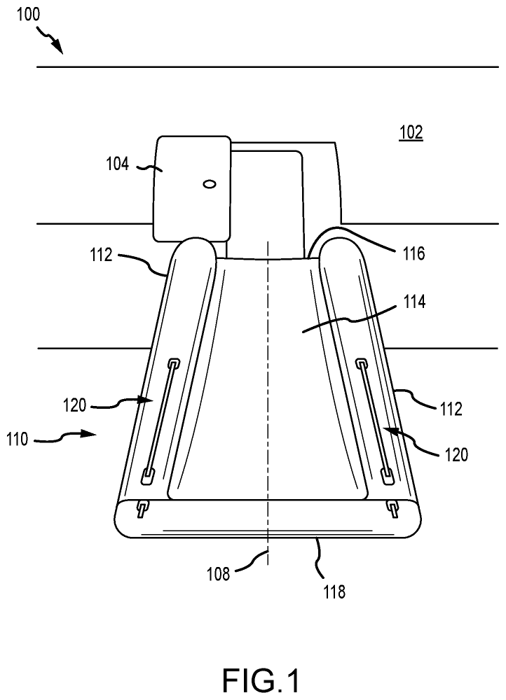

Referring to FIG. 1, an aircraft 100 having an evacuation slide 110, according to various embodiments, is illustrated. The aircraft 100 may include a fuselage 102 with wings fixed to the fuselage 102. An emergency exit door 104 may be disposed on the fuselage 102 over one of the wings or at some other location along a length of the fuselage 102. The evacuation slide 110 and other components of an evacuation system may be housed within a pack-board housing or other compartment mounted to the aircraft 100. The evacuation system may jettison a blowout panel to deploy the evacuation slide 110, such as, for example, an inflatable evacuation slide, in response to the emergency exit door 104 opening or in response to another evacuation event. FIG. 1 schematically depicts the evacuation slide 110 in a deployed state, extending from the fuselage 102 of the aircraft 100. During deployment, an inflatable tube 112 (or a plurality of inflatable tubes) is inflated using an inflation system that is typically configured to deliver a pressurized gas to the inflatable tube 112. The evacuation slide may comprise a sliding surface 114 secured to the inflatable tube 112 and configured for sliding passenger egress from the emergency exit door 104 of the aircraft 100 to a surface on the ground in the event of an evacuation on land or to a water surface in the event of an evacuation on a lake, river or ocean. In various embodiments, the evacuation slide 110 includes a longitudinal axis 108 that extends from a first or a proximal end 116 (or a head portion) to a second or a distal end 118 (or a foot portion). As described further below, in various embodiments, the evacuation slide 110 may comprise a restraint assembly 120 disposed on the inflatable tube 112 (or on each inflatable tube comprised within the evacuation slide 110).

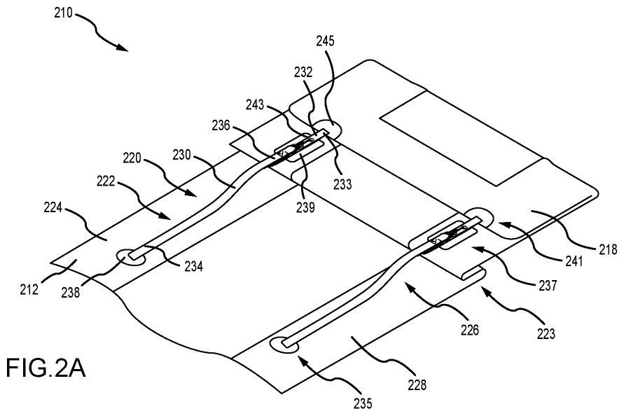

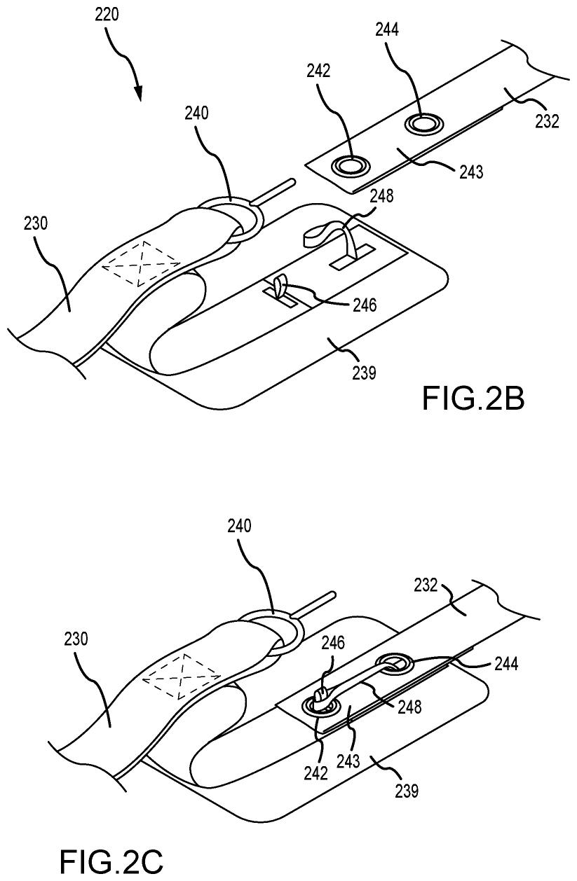

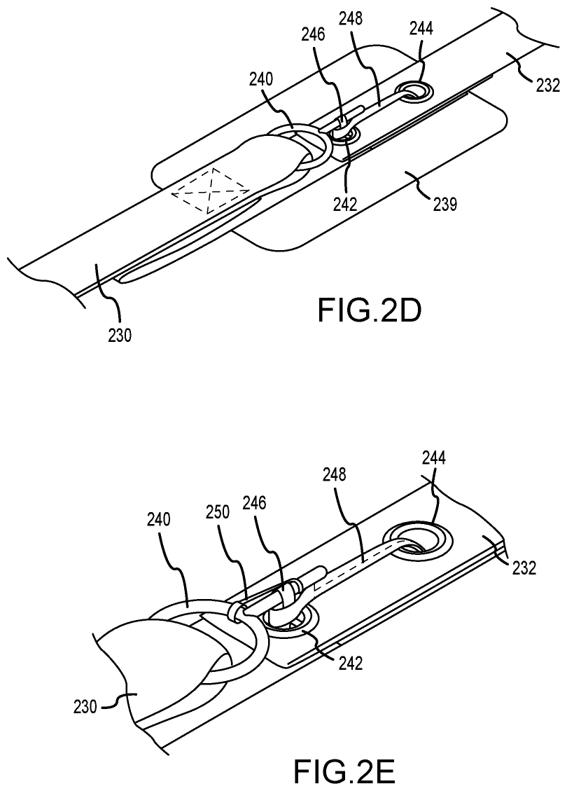

Referring now to FIGS. 2A, 2B, 2C, 2D and 2E, a restraint assembly 220, similar to the restraint assembly 120 described above, is illustrated with reference to an evacuation slide 210, similar to the evacuation slide 110 described above. In various embodiments, a first restraint assembly 222 is disposed on a first inflatable tube 224 and a second restraint assembly 226 is disposed on a second inflatable tube 228. Without loss of generality, various features of the first restraint assembly 222 and the second restraint assembly 226 are described with reference to the restraint assembly 220 disposed on an inflatable tube 212 (e.g., the inflatable tube 112 described above), which may represent either of the first inflatable tube 224 and the second inflatable tube 228. Further, it is noted that locating a restraint assembly on each of the inflatable tubes provides a symmetrical dual action restraint system that enables the evacuation slide 210 to unfold during deployment in a symmetrical fashion—e.g., without twisting, where one inflatable tube deploys at a different rate than another inflatable tube.

The restraint assembly 220 includes a first strap 230 defining a first strap length and a second strap 232 defining a second strap length. The first strap 230 has a first end 234 attached to the inflatable tube 212 at a first location 235 intermediate a head portion (e.g., the first or proximal end 116) and a foot portion 218 (e.g., the second or distal end 118) and a second end 236 attached to the inflatable tube 212 at a second location 237 proximate the foot portion 218. In various embodiments, the first end 234 is attached to the inflatable tube 212 via a first patch 238 that is bonded to the inflatable tube 212 via an adhesive. Similarly, the second end 236 is attached to the inflatable tube 212 via a second patch 239 that is bonded to the inflatable tube 212 via an adhesive. The second strap 232 has a first end 233 attached to the inflatable tube 212 at a third location 241 at the foot portion 218 and a second end 243 that remains free and not attached to the inflatable tube 212. In various embodiments, the first end 233 is attached to the inflatable tube via a third patch 245 that is bonded to the inflatable tube 212 via an adhesive.

Referring more particularly now to FIGS. 2B, 2C, 2D and 2E, further details of the restraint assembly 220 are described with reference to various steps of a packing process completed to configure the evacuation slide 210 for deployment. As illustrated in FIG. 2B, the second end 243 of the second strap 232 includes a first grommet 242 (or a first aperture) and a second grommet 244 (or a second aperture), the second grommet 244 being spaced a first distance from the first grommet 242 along a length of the second strap 232. The restraint assembly 220 further includes a first loop 246 attached to the second patch 239 and a second loop 248 attached to the second patch 239. In various embodiments, the first loop 246 is spaced the first distance from the second loop 248. The first loop 246 is configured to extend through the first grommet 242 and the second loop is configured to extend through the second grommet 244 when the second end 243 of the second strap 232 is positioned over the second patch 239. As illustrated in FIG. 2C, the second loop 248 includes a length sufficient to extend the first distance separating the first grommet 242 and the second grommet 244.

During the packing process, the evacuation slide 210 is first z-folded at a z-fold location 223 proximate the second patch 239. Z-folding the evacuation slide 210 enables the second end 236 of the first strap 230 to reach the second end 243 of the second strap 232. Further, the z-folding is typically employed to accommodate the first strap length being less than a second distance, defined as the length between the first location 235 and the second location 237 when the evacuation slide is laid out in a completely unfolded state. Next, the first loop 246 and the second loop 248 are threaded, respectively, through the first grommet 242 and the second grommet 244. Once the first loop 246 and the second loop 248 are threaded through the first grommet 242 and the second grommet 244, the first loop 246 is then threaded through the second loop 248, as illustrated in FIG. 2C. A release pin 240 attached to the first strap 230 is then inserted into the first loop 246 to secure the second end 243 of the second strap 232 to the second patch 239, as illustrated in FIG. 2D. Once the release pin 240 has been inserted through the first loop 246 the release pin 240 is secured to the first loop via a securing thread 250 configured to break when a threshold breaking load is reached between the first strap 230 and the second strap 232 during inflation of the evacuation slide 210.

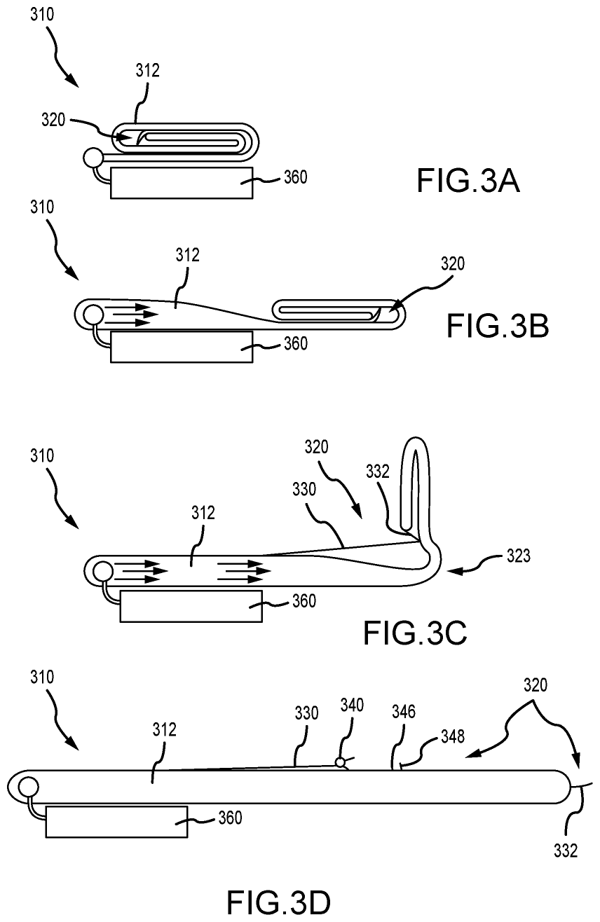

Referring now to FIGS. 3A, 3B, 3C and 3D, an evacuation slide 310 comprising an inflatable tube 312 and a restraint assembly 320 (similar to the restraint assembly 220 described above) is illustrated undergoing various stages of deployment, in accordance with various embodiments. Referring first to FIG. 3D, the restraint assembly 320 is illustrated in a “broken” or “released” state, whereby during inflation of the inflatable tube 312, a first strap 330 has broken away from or has been released from connection to a second strap 332 (similar to the first strap 230 and the second strap 232 described above). As illustrated in FIG. 3D, the restraint assembly 320, similar to the restraint assembly 220 described above, includes the first strap 330 and the second strap 332, as well as a first loop 346 and a second loop 348 attached to the inflatable tube 312 and a release pin 340 configured to secure the first strap 330 to the second strap 332, as described above with reference to FIGS. 2A-2E.

Referring now to FIG. 3A, the evacuation slide is illustrated in a fully packed state, following completion of the packing process described above. Upon initiation of deployment, a pressurized gas source 360 begins inflation of the evacuation slide 310 (or the inflatable tube 312), as illustrated at FIG. 3B. As illustrated in FIG. 3C, inflation of the evacuation slide 310 continues to a point where the first strap 330 and the second strap 332 are placed into a state of tension following inflation of a z-folded portion of the evacuation slide 310 located at a z-fold location 323 (also similar to the z-folding of the evacuation slide 210 at the z-fold location 223 described above). Inflation of the evacuation slide 310 continues, increasing the tension between the first strap 330 and the second strap 332, until a securing thread (similar to the securing thread 250 described above) breaks, thereby enabling the first strap 330 to become separated from the second strap 332. Once the first strap 330 becomes separated from the second strap 332, the evacuation slide 310 continues with inflation until the slide is fully deployed, as illustrated in FIG. 3D.

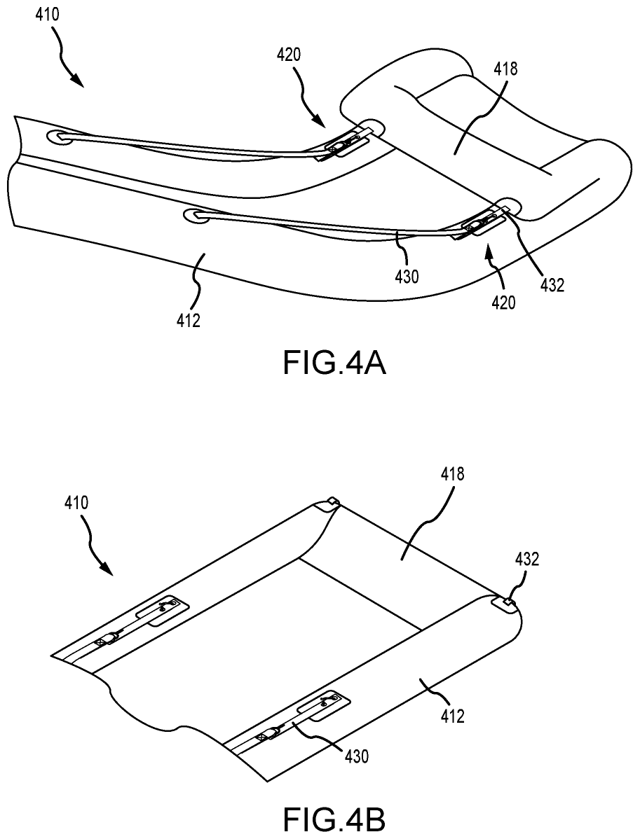

Referring now to FIGS. 4A and 4B, a perspective view of an evacuation slide 410 comprising an inflatable tube 412 and a restraint assembly 420 (similar to the restraint assembly 220 described above) is illustrated undergoing the latter two stages of deployment described above with reference to FIGS. 3C and 3D, in accordance with various embodiments. As illustrated in FIG. 4A, during inflation of the inflatable tube 412, a first strap 430 and a second strap 432 of the restraint assembly 420 are placed in a state of tension. Inflation of the evacuation slide 410 continues, increasing the tension between the first strap 430 and the second strap 432, until a securing thread (similar to the securing thread 250 described above) breaks, thereby enabling the first strap 430 to become separated from the second strap 432. Once the first strap 430 becomes separated from the second strap 432, the evacuation slide 410, including a foot portion 418 of the evacuation slide 410, continues with inflation until the slide assumes a fully deployed state, as illustrated in FIG. 4B.

The restraint assembly for the evacuation slide described above enables controlled deployment in various environmental conditions, particularly where strong winds are encountered during an evacuation from an aircraft. As noted above, locating a restraint assembly on each of the inflatable tubes of the evacuation slide provides a symmetrical dual action restraint system that enables greater control of the unfolding process of the evacuation slide during deployment, ensuring the evacuation slide deploys in a symmetrical fashion—e.g., without twisting, where one inflatable tube deploys at a different rate than another inflatable tube. The restraint assembly offers reduced complexity and, therefore, fewer required steps during a packing or folding process and the design provides a greater level of mistake-proofing. Further, the design of the restraint assembly facilitates use on both inflatable tubes, rather than left and right assemblies that may have different structures to accommodate use on left and right-sided inflatable tubes. The use of grommets also provides less friction against the loops as does current designs having multiple connected fabric loops.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed:

1. A restraint assembly for an evacuation slide having an inflatable tube that defines a head portion and a foot portion, comprising:
a first strap having a first end configured for attachment to the inflatable tube at a first location, intermediate the head portion and the foot portion, and a second end configured for attachment to the inflatable tube at a second location, proximate the foot portion;
a second strap having a first end configured for attachment to the inflatable tube at a third location, distal of the second location, the second strap having a first aperture and a second aperture proximate a second end of the second strap, the second aperture spaced a first distance from the first aperture;
a first loop configured for attachment to the inflatable tube at the second location and configured for threading through the first aperture; and
a second loop configured for attachment to the inflatable tube at the second location and spaced the first distance from the first loop.

2. The restraint assembly of claim 1, wherein the second loop has a length about equal to the first distance.

3. The restraint assembly of claim 2, wherein the first loop is configured for threading through the second loop.

4. The restraint assembly of claim 3, further comprising a release pin attached to the second end of the first strap.

5. The restraint assembly of claim 4, wherein the release pin is configured for threading through the first loop following the first loop being threaded through the second loop.

6. The restraint assembly of claim 1, wherein the first aperture is defined by a first grommet.

7. The restraint assembly of claim 6, wherein the second aperture is defined by a second grommet.

8. The restraint assembly of claim 1, wherein the first location is spaced a second distance from the second location and the first strap defines a first strap length that is less than the second distance.

9. The restraint assembly of claim 8, wherein the third location is positioned on the foot portion.

10. The restraint assembly of claim 9, wherein the second strap defines a second strap length that is less than the first strap length.

11. An evacuation slide, comprising:
an inflatable tube that defines a head portion and a foot portion;
a first strap having a first end attached to the inflatable tube at a first location, intermediate the head portion and the foot portion, and a second end attached to the inflatable tube at a second location, proximate the foot portion;
a second strap having a first end attached to the inflatable tube at a third location, distal of the second location, the second strap having a first aperture and a second aperture proximate a second end of the second strap, the second aperture spaced a first distance from the first aperture;
a first loop attached to the inflatable tube at the second location and configured for threading through the first aperture; and
a second loop attached to the inflatable tube at the second location, the second loop spaced the first distance from the first loop.

12. The evacuation slide of claim 11, wherein the second loop has a length about equal to the first distance.

13. The evacuation slide of claim 12, wherein the first loop is configured for threading through the second loop.

14. The evacuation slide of claim 13, further comprising a release pin attached to the second end of the first strap.

15. The evacuation slide of claim 14, wherein the release pin is configured for threading through the first loop following the first loop being threaded through the second loop.

16. The evacuation slide of claim 11, wherein the first aperture is defined by a first grommet.

17. The evacuation slide of claim 16, wherein the second aperture is defined by a second grommet.

18. The evacuation slide of claim 11, wherein the first location is spaced a second distance from the second location and the first strap defines a first strap length that is less than the second distance.

19. The evacuation slide of claim 18, wherein the third location is positioned on the foot portion.

20. The evacuation slide of claim 19, wherein the second strap defines a second strap length that is less than the first strap length.
